(19) United States
(12) Patent Application Publication
(10) Pub. No.: US 2023/0198845 A1
(43) Pub. Date: Jun. 22, 2023

(54) SYSTEMS AND METHODS OF CONFIGURING MONITORING OPERATIONS FOR A CLUSTER OF SERVERS

(71) Applicant: Rakuten Mobile, Inc., Tokyo (JP)

(72) Inventors: Mohit LUTHRA, Singapore (SG); Abhishek SHARMA, Tokyo (JP); Suyash Arun BHATKAR, Tokyo (JP); Bharath RATHINAM, Tokyo (JP); Rajat Kumar SINGH, Tokyo (JP)

(21) Appl. No.: 17/644,587

(22) Filed: Dec. 16, 2021

(51) Int. Cl. H04L 41/0866; H04L 41/0806

(52) U.S. Cl. CPC H04L 41/0866; H04L 41/0806

(57) ABSTRACT

Embodiments of systems and methods of configuring a cluster of servers is disclosed. In one embodiment of a method, an orchestrator application registers a cluster of servers. The orchestrator application installs a monitoring agent on the cluster of servers with application, wherein the orchestrator application is configured to generate agent configuration data in response to installing the monitoring agent. In response to installing the monitoring agent, the agent configuration data is sent to a cluster monitoring application. The cluster monitoring application configures, the monitoring agent to transmit cluster operation data to the cluster monitoring application based on the sent agent configuration data.

### BACKGROUND

The operation of servers and clusters of servers are monitored in order to ensure that the servers are operating appropriately and efficiently. However, configuring the cluster of servers to transmit operational data to the appropriate network locations is an arduous task that has often taken days and even weeks to complete. Applications on the cluster of servers have to be configured to communicate with applications at other network locations in order to properly monitor the operational data. Not only is this task arduous, but previously involved exchanging sensitive server configuration information in insecure environments that are subject to cyber piracy.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a data storage system, in accordance with some embodiments.

FIG. 2 is a block diagram of a data storage system that a cluster monitoring device and a cluster of servers along with software application that are implemented by the cluster monitoring device and the cluster of servers, in accordance with some embodiments.

FIG. 3 is a flowchart of an exemplary method of method of configuring the cluster of servers, in accordance with some embodiments.

FIG. 4 is a visual representation of registration data, in accordance with some embodiments.

FIG. 5 is a visual representation of agent configuration data, in accordance with some embodiments.

FIG. 6 is a visual representation of a configuration outcome message, in accordance with some embodiments.

FIG. 7 is a block diagram of a cluster monitoring application and a target cluster of servers, in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

(Optional, use when applicable) Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

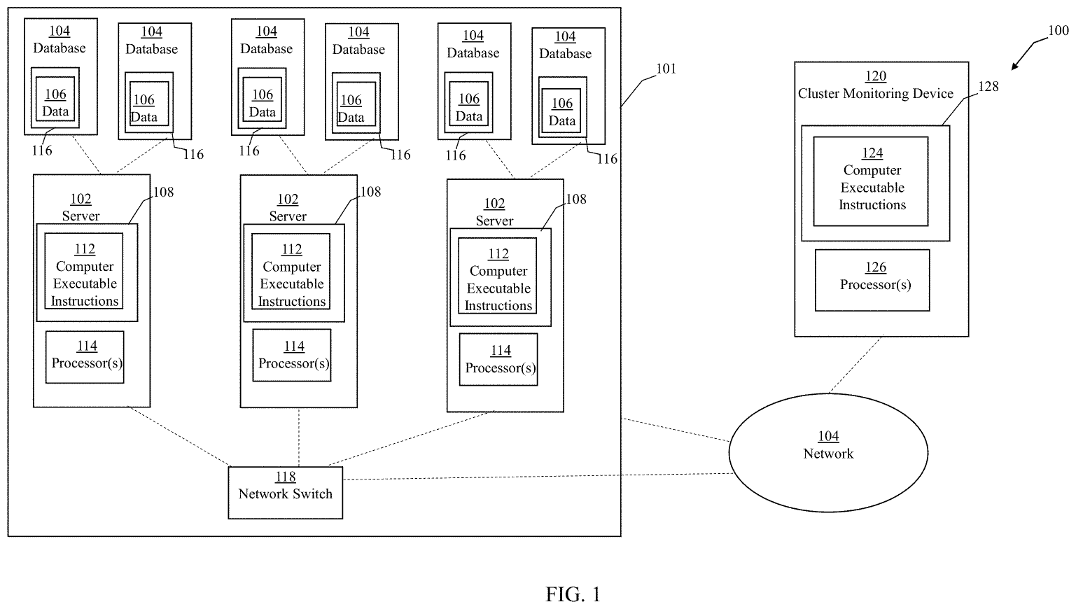

FIG. 1 is a block diagram of a data storage system 100, in accordance with some embodiments.

Data storage system 100 includes a cluster 101 of servers 102. Each of the servers 102 is operably connected to databases 104. A cluster 101 of servers 102 is a group of servers 102 that operate as a logical entity. To do this, servers 102 in the cluster 101 are connected to a network switch 118, which administers and manages commands, messaging, and other types of communications to the individual servers 102 in the cluster 101. The network switch 118 is connected to a network 104 and thus the servers 102 are connected to the network 104 through the network switch 118. The servers 102 are configured to manage the writing and reading of data 106 to non-transitory computer readable media 108 in the databases 104. In some embodiments, the network 104 includes a wide area network (WAN) (i.e., the internet), a wireless WAN (WWAN) (i.e., a cellular network), a local area network (LAN), and/or the like. To manage the writing and reading of data 106 in the databases 104 and to perform other functionality, the servers 102 implement include computer executable instructions 112. In some embodiments, the computer executable instructions 112 are organized as different software applications that are implemented by one or more processors 114 in each of the servers 102. The computer executable instructions 112 are stored on non-transitory computer readable medium 116 within each of the servers 102. In some embodiments, non-transitory computer-readable media 108, 116 include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer. Also, in FIG. 1, each of the servers 102 is configured to manage more than one of the databases 104. In some embodiments, the data storage system 100 includes a single server 102 and a single database 104. In some embodiments, the data storage system 100 includes multiple servers 102 that manage a single database 104. In some embodiments, multiple servers 102 are configured to manage the same subset of databases 104. These and other configurations for the data storage system 100 are within the scope of this disclosure.

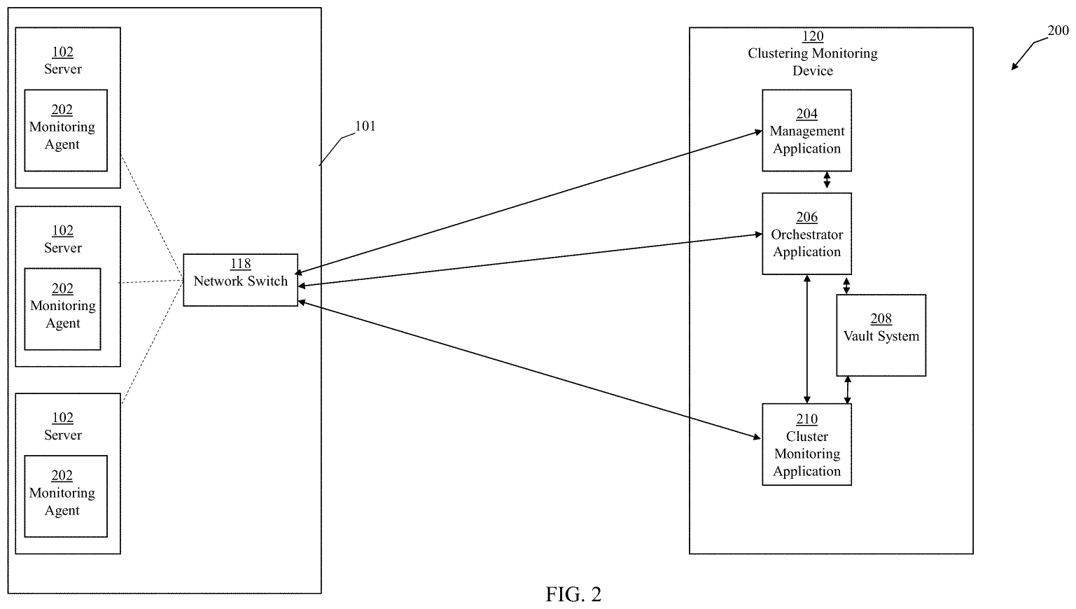

In FIG. 1, the data storage system 100 includes the cluster 101 of the servers 102 that operate the databases 104 and a cluster monitoring device 120. The cluster monitoring device 120 is a computer device that monitors the characteristics and operational performance of the cluster 101 and the individual servers 102 within the cluster 101. In some embodiments, the cluster monitoring device 120 is configured to implement a cluster monitoring application (an example of which is discussed with respect to FIG. 2 below) that monitors the operational performance of the cluster 101. The cluster monitoring device 120 implements the cluster monitoring application as computer executable instructions 124 executed on one or more processors 126. The computer executable instructions 124 are stored on a non-transitory computer readable medium 128. In some embodiments, non-transitory computer-readable media 128 include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer device.

The cluster 101 of the servers 102 implement monitoring agents (examples of which is discussed below with respect to FIG. 2) in a cloud-based manner for the cluster 101 as a whole and/or in an individual manner for each of the servers 102. The monitoring agents transmit operational data to the cluster monitoring application so that the cluster monitoring application reports and analyses the operational data so that the cluster 101 of the servers 102 can be administered. A complication of this configuration is the setup of the cluster monitoring application with the monitoring agent. In other approaches, many of the steps required for this setup were done manually. Configuration data regarding the monitoring agents had to be obtained through individual queries by maintenance personnel. This configuration data then had to be shared with maintenance personnel at the cluster monitoring device 120 so that endpoints between the monitoring agent and the cluster monitoring application had to be manually set up. In other words, maintenance personnel had to tell the monitoring agents what cluster monitoring application to communicated with and how to communicate with that cluster monitoring application. This process often took weeks to complete. Furthermore, this process often presented significant security issues as this information was often shared in an insecure manner such as through emails. However, in some embodiments, the cluster monitoring device 120 is configured to implement an orchestrator (an example of which is discussed with respect to FIG. 2) that is configured to automatically configure the monitoring agents to communicate with the cluster monitoring application. Furthermore, in some embodiments, the orchestrator is configured to perform these operations through a vault system that secures the configurations of the monitoring agents with the cluster monitoring application against cyber piracy which is not possible with respect to manual implementation.

FIG. 2 is a block diagram of a data storage system 200 that the cluster monitoring device 120 and the cluster 101 of servers 102 along with software application that are implemented by the cluster monitoring device 120 and the cluster 101 of servers 102, in accordance with some embodiments.

In FIG. 2, each of the servers 102 implements a monitoring agents 202. The monitoring agents 202 are implemented by executing the computer executable instructions 112 with the processors 114 in each of the servers 102. In FIG. 2, each of the servers 102 implement one of the monitoring agents 202. In other embodiments, one or more of the servers 102 implements more than one monitoring agent 202. In some embodiments, each of the monitoring agents 202 operates collectively so as to operate as a monitoring agent for the cluster 101 as a whole. In some embodiments, the monitoring agents 202 operate on each of the servers 102 individually.

Monitoring agents 202 are implemented by any software application that gathers cluster operation data regarding the performance of the cluster 101 and/or the servers 102 and transmits this data to a cluster monitoring application. By way of a non-limiting example, in some embodiments, the monitoring agents 202 are configured to collect, transfer and store performance data related to the servers 102 and other network equipment, gathers metrics from various sources (e.g., the operating system, applications, logfiles and external devices), and gather statistics used to system monitoring and to find performance bottlenecks. For example, the monitoring agents 202 are daemons such as collected.

In some embodiments, the monitoring agents 202 are configured as lightweight shippers for forwarding and centralizing log data. The monitoring agents 202 monitor log files or specified locations, collect log events, and forward this information to indexing applications such as Elasticsearch or Logstash.

In some embodiments, the monitoring agents 202 are configured as open-source light-weight utilities used as a collective to monitor the cluster 101. In some embodiments, the monitoring agents 202 reports the state of objects by listening to an application programming interface (API), such as a Kubernetes API.

The client monitoring device 120 implements a management application 204, an orchestrator application 206, a vault system 208, and a cluster monitoring application 210. The management application 204 is configured to provide life cycle management of hardware and software components on the cluster 101 of servers. In some embodiments, the management application 204 provides life cycle management to hardware components in computer devices, storage devices, and network devices. In some embodiments, the management application 204 provides life-cycle management to software components such as firmware, kernels, operating systems, drivers, services, libraries, and robin clusters.

The orchestrator application 206 automatically configures the setup of the monitoring agents 202 with the cluster monitoring application 210. The vault system 208 is an application that stores usernames, passwords in authentication tokens in a secure locations and/or in an encrypted format. The vault system 208 is sometimes referred to as a password manager. In FIG. 2, the vaults system 208 is being implemented to secure certain information (discussed below) during the setup of the monitoring agents 202 and the cluster monitoring application 210 by the orchestrator application 206. The cluster monitoring application 210 is configured to use the cluster operation data from the monitoring agents 202 in order to monitor and analyze cluster performance. In some embodiments, the cluster monitoring application 210 is configured to generate alerts and present information regarding possible scenarios related to the cluster 101 of servers 102. One non-limiting example of a cluster monitoring application 210 is an observability framework (OBF). In some embodiments, the OBF is a cloud-based solution for monitoring and analyzing logs of multiple micro services implemented by the cluster 101 of servers 102. In some embodiments, the cluster monitoring application 210 is a Kubernets API.

The management application 204, the orchestrator application 206, the cluster monitoring application 210 communicates with the monitoring agents 202 through the network switch 118, which manages traffic through the cluster 101. The management application 204 communicates certain registration data regarding the cluster 101 with the orchestrator application 206, as detailed below. The orchestrator application 206 stores an access token to the cluster 101 in the vault system 206 and provides cluster configuration data to the cluster monitoring application 210 so that the cluster monitoring application 210 is set up to communicate with the monitoring agents 202 in the cluster 101, as detailed below.

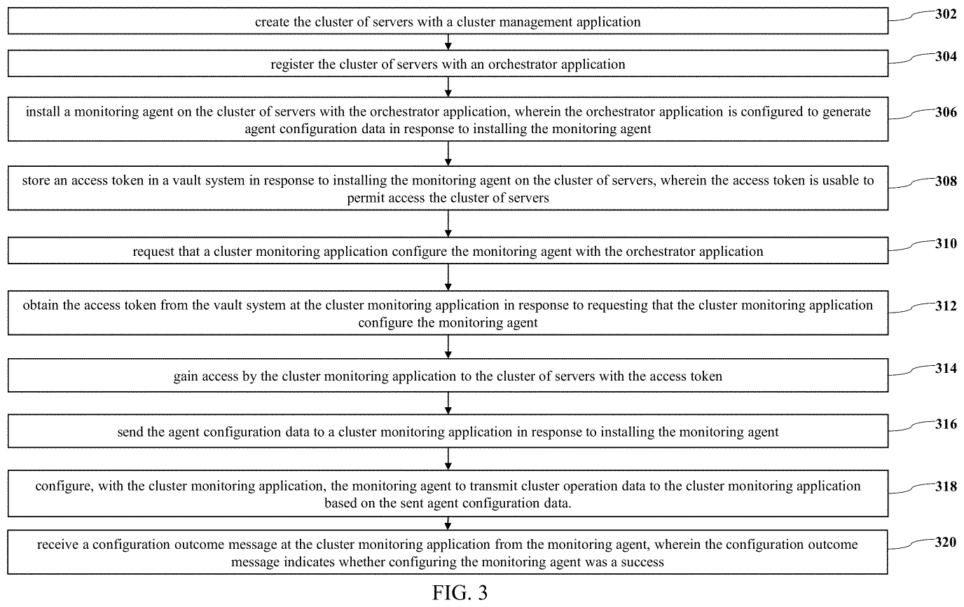

FIG. 3 is a flowchart 300 of an exemplary method of method of configuring the cluster 101 of servers 102, in accordance with some embodiments.

In some embodiments, the method described by the flowchart 300 in FIG. 3 is performed by the data storage system 100, 200 illustrated in FIG. 1 and FIG. 2 by the cluster monitoring device 120. Flow begins a block 302.

At block 302, the cluster monitoring device 120 creates the cluster 101 of the servers 102 with the cluster management application 204. In some embodiments, the cluster management application 120 is configured to generate registration data with registration information associated with the cluster 101 of the servers 102. In some embodiments, the registration data includes information related to a data center that houses the cluster 101 of servers 102, network addresses and/or identification data that identifies the cluster of servers 102 on the network 104, the readiness status of the cluster 101 of servers 102, codes that identify the cluster 101 of servers 102, and/or the like. Flow then proceeds to block 304.

At block 304, the cluster monitoring device 120 registers the cluster 101 of servers 102 with the orchestrator application 206. To register the cluster 101 of servers 102, the management application 204 sends the registration data with registration information associated with the cluster 101 of servers 102 to the orchestrator application 206. In this manner, the orchestrator application 206 obtains the registration information used to identify and communicate with the cluster 101 of servers 102. In some embodiments, the orchestrator application 206 is configured to use the registration data to also determine the cluster monitoring application 210 that the monitoring agents 202 are to be set up with. In some embodiments, the cluster monitoring device 120 is configured to implement various cluster monitoring applications simultaneously. In some embodiments, there are various cluster monitoring devices implementing cluster monitoring applications. Thus, in some embodiments, the particular cluster monitoring application that is to communicate with the monitoring agents 202 in the cluster 101 are identified by the registration data. Flow then proceeds to block 306.

At block 306, the cluster monitoring device 120 is configured to install one or more of the monitoring agents 202 on the cluster 101 of servers 102 with the orchestrator application 206. The orchestrator application 206 is configured to generate agent configuration data in response to installing the monitoring agent(s) 202. In some embodiments, the agent configuration data identifies where the monitoring agent(s) 202 are deployed, details regarding a data center having the cluster 101 of servers 102, identifiers of the cluster 102, endpoints of the monitoring agent(s) 202, and/or the like. Note that the agent configuration data is safely within the cluster monitoring device 120 and does not have to be sent in an unsecure manner to other devices for setup. Flow then proceeds to block 308.

At block 308, the orchestrator application 206 stores an access token in the vault system 208 in response to installing the monitoring agent(s) 202 on the cluster 101 of the servers 102. The access token is usable to permit access to the cluster 101 of the servers 102. Thus, the cluster 101 of servers 102 do not allow any type of setup with the monitoring agent(s) 202 unless the appropriate access token is provided. Flow then proceeds to block 310.

At block 310, the cluster monitoring device 120 requests that the cluster monitoring application 210 configure the monitoring agent(s) 202 with the orchestrator application 206. In some embodiments, the orchestrator application 206 sends a request message to the cluster monitoring application 210 that the cluster monitoring device 120 initiate set up with the monitoring agent(s) 202. Flow then proceeds to block 312.

At block 312, the cluster monitoring application 210 obtains the access token from the vault system 208 in response to the cluster monitoring device 120 requesting that the cluster monitoring application 210 configure the monitoring agent(s) 202. Flow then proceeds to block 314.

At block 314, the cluster monitoring application 210 gains access to the cluster 101 of servers 102 with the access token. In some embodiments, this involves security handshaking between the cluster monitoring application 210 and the cluster 101 of servers 102 so that the cluster monitoring application gains access to the cluster 101 with the access token. In some embodiments, the access toke in a cryptographic key, password, and/or hash. Flow then proceeds to block 316.

At block 316, the orchestrator application 206 sends the agent configuration data to the cluster monitoring application 210 in response to installing the monitoring agent(s) 202. In this manner, the cluster monitoring application 210 has the information that is to be used to set up communication between endpoints in the cluster monitoring application 210 and endpoints of the monitoring agent(s) 202. Flow then proceeds to block 318.

At block 318, the cluster monitoring application 210 configures the monitoring agent(s) 202 to transmit cluster operation data to the cluster monitoring application 210 based on the sent agent configuration data. In this manner, the cluster monitoring application 210 is set up to begin monitoring the operational performance of the cluster 101 of the servers 102. In some embodiments, the cluster monitoring application 210 configures the monitoring agent(s) 202 to transmit cluster operation data to the cluster monitoring application 210 through wired network communications. In some embodiments, the cluster monitoring application 210 configures the monitoring agent(s) 202 to transmit cluster operation data to the cluster monitoring application 210 through wirelessly. Flow then proceeds to block 320.

At block 320, the cluster monitoring program 210 is configured to receive a configuration outcome message from the monitoring agent 202. The configuration outcome message indicates whether configuring the monitoring agent was a success. In this manner, the cluster monitoring agent 210 receive confirmation the monitoring operations are ready to begin.

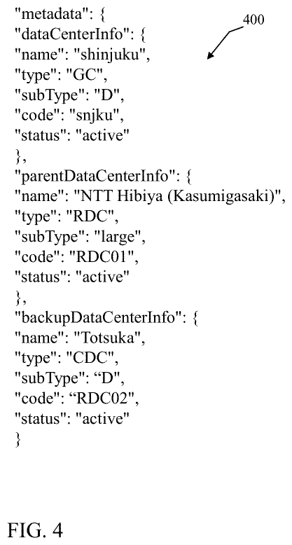

FIG. 4 is a visual representation of registration data 400, in accordance with some embodiments.

In FIG. 4, the registration data 400 is provided as a data structure with various data fields. The registration data 400 is sent by the management application 204 to the orchestrator application 206 at block 304 in accordance with some embodiments. In this embodiment, the registration data 400 includes data center information (labeled “dataCenterInfo”), which is a subdata structure. The data center information includes a “name” field, which in this example is filled with the name shinjuku, a “type” field, which in this example is filled in with the type GC, a “subtype” field, which in this example is filled in with the subtype D, a “code” field, which in this example is filled in with the code snjku, and a “status” field, which in this example is filled with the status of active. The “name” field is the name of the datacenter. The “type” field is the type of data center. In some embodiments, the data center is a far edge datacenters and the type of datacenter is a group datacenter (labeled GC), an edge datacenter (also known as a regional data center) (labeled RGC) and a main central data center labeled CDC. The “subtype” field indicates a size of the data center. The “code” field includes a unique code that identifies the data center, and the “status” field indicates the status of the data center.

In some embodiments, the registration data 400 includes parent data center information (labeled “parentDataCenterInfo”), which is a subdata structure. The parent data center information include a “name” field, which in this example is filled with the name Kasumigasaki, a “type” field, which in this example is filled in with the type RDC, a “subtype” field, which in this example is filled in with the subtype large, a “code” field, which in this example is filled in with the code RDC01, and a “status” field, which this example is filled with the status of active.

In some embodiments, the registration data 400 includes backup data center information (labeled “backupDataCenterInfo”), which is a subdata structure. The backup data center information include a “name” field, which in this example is filled with the name Totsuka, a “type” field, which in this example is filled in with the type CDC, a “subtype” field, which in this example is filled in with the subtype D, a “code” field, which in this example is filled in with the code RDCO2, and a “status” field, which this example is filled with the status of active. In some embodiments, the orchestrator application 206 is configured to find out the client monitoring application being implemented by the data center, the parent data center, and the backup datacenter.

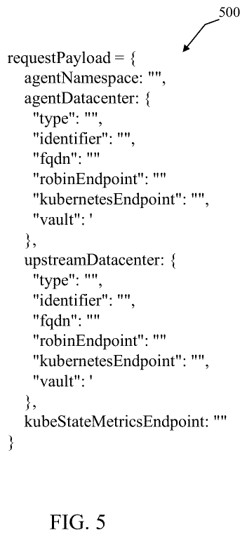

FIG. 5 is a visual representation of agent configuration data 500, in accordance with some embodiments.

In FIG. 5, the agent configuration data 500 is provided as a data structure with various data fields. The agent configuration data 500 is sent by the orchestrator application 206 to the cluster monitoring application 210 at block 316 in accordance with some embodiments. In this embodiment, the agent configuration data 500 includes agent information (labeled “agentNamespace”), which is a subdata structure. The agent information identifies where the agents are deployed. In some embodiments, the agent information identifies a Kubernetes namespace. The agent information includes data substructure named “agentDatacenter.” In some embodiments, the data substructure “agentDatacenter” provides details regarding the data center of the agent, such as an Edgedata center.

In FIG. 5, the data substructure “agentDatacenter” includes a “type” field, an “identifier” field, a “fqdn” field, a “robinEndpoint” field, a “kubernetesEndpoint” field, and a “vault” field. The “type” field identifies the type of datacenter. The “identifier” field includes a unique identifier that identifies a particular cluster 101 in which the monitoring agent 202 is deployed. The “fqdn” field identifies a fully qualified domain name (FQDN) of a target datacenter. The “robinEndpoint” field identifies robin end points for cluster access. The “kubernetesEndpoint” field identifies kubernetes end points for cluster access. The “vault” field identifies a network location of the vault system 208 where cluster credentials unique to the cluster 101 are stored.

In FIG. 5, data substructure “agentNamespace” also includes an “upstreamDatacenter” data substructure. The “upstreamDatacenter” data substructure identifies a parent datacenter. The data substructure “upstreamDatacenter” also includes a “type” field, an “identifier” field, a “fqdn” field, a “robinEndpoint” field, a “kubernetesEndpoint” field, and a “vault” field.

In FIG. 5, the data substructure “agentNamespace” includes a “kubestatemetricsEndpoint” field that identifies endpoints of the monitoring agent 202 on the cluster 101.

The cluster monitoring application 210 is configured to receive the agent configuration data 500, login to the cluster 101, and configure the monitoring agent 202 associated with the agent configuration data 500 to transmit cluster operation data to the cluster monitoring application based on the sent agent configuration data 500, in accordance with block 318 in FIG. 2.

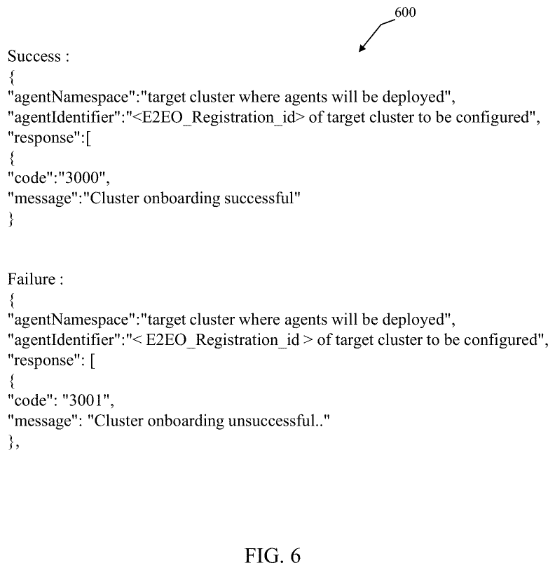

FIG. 6 is a visual representation of a configuration outcome message 600, in accordance with some embodiments.

In FIG. 6, the configuration outcome message 600 is provided as a data structure with various data fields. The configuration outcome message 600 is sent by the monitoring agent 202 to the cluster monitoring application 210 at block 320 in accordance with some embodiments.

In FIG. 6, the configuration outcome message 600 includes a “Success” data substructure that identifies relevant agent information when block 318 is a success. The “Success” data substructure includes an “agentNamespace” field that identifies the target cluster where the monitoring agent will be deployed, an “agentIdentifier” field that includes a registration identifier of the target cluster to be configured, and a “response” data substructure. The “response” data substructure includes a “code” text field with the value “3000” and a “message” text field with the message “Cluster onboarding successful.”

In FIG. 6, the configuration outcome message 600 includes a “Failure” data substructure that identifies relevant agent information when block 318 is a failure. The “Failure” data substructure includes an “agentNamespace” field, an “agentIdentifier” field, and a “response” data substructure. The “response” data substructure includes a “code” text field with the value “3001” and a “message” text field with the message “Cluster onboarding unsuccessful.”

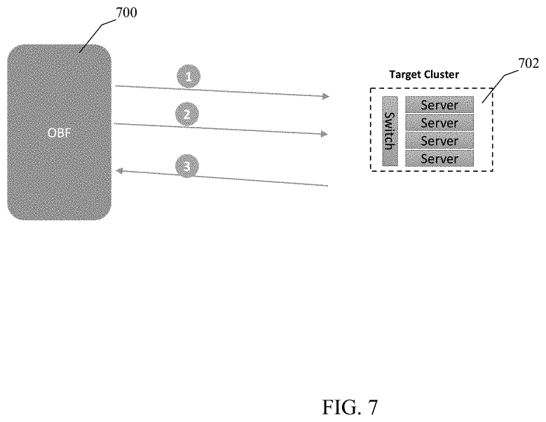

FIG. 7 is a block diagram of a cluster monitoring application 700 and a target cluster 702 of servers, in accordance with some embodiments.

In FIG. 7, the cluster monitoring application 700 is an OBF. The cluster monitoring application 700 is an example of the cluster monitoring application 210 in FIG. 2, in accordance with some embodiments. The cluster monitoring application 700 sets up monitoring agents 202 in FIG. 2.

The cluster monitoring application 700 receives a request from the orchestrator application 206 (See FIG. 2) to start configuration of the monitoring agents 202. The cluster monitoring application 700 checks the monitoring agents state (e.g., whether the monitoring agent deployed successfully). In some embodiments, the cluster monitoring application 700 configures the end point URL of the cluster monitoring application 700 where those monitoring agents 202 are supposed to send the event data regarding events and matrices. Once the cluster monitoring application 700 starts receiving the event data/matrices from the monitoring agents 202, the cluster monitoring application 700 records the set up procedure as complete and sends a response back to orchestrator application 206 (See FIG. 2) that the monitoring agents have been set up.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method of configuring a cluster of servers, comprising:
registering the cluster of servers with an orchestrator application;
installing a monitoring agent on the cluster of servers with the orchestrator application, wherein the orchestrator application is configured to generate agent configuration data in response to installing the monitoring agent;
sending the agent configuration data to a cluster monitoring application in response to installing the monitoring agent;
configuring, with the cluster monitoring application, the monitoring agent to transmit cluster operation data to the cluster monitoring application based on the sent agent configuration data.

2. The method of claim 1, further comprising:
prior to registering the cluster of servers with the orchestrator application, creating the cluster of servers with a cluster management application, wherein the cluster management application is configured to generate registration data with registration information associated with the cluster of servers;
wherein registering of the cluster of servers with the orchestrator application comprises sending the registration data with registration information associated with the cluster of servers to the orchestrator application.

3. The method of claim 1, further comprising:
storing an access token in a vault system in response to installing the monitoring agent on the cluster of servers, wherein the access token is usable to permit access the cluster of servers;
requesting that the cluster monitoring application configure the monitoring agent with the orchestrator application; and
obtaining the access token from the vault system at the cluster monitoring application in response requesting that the cluster monitoring application configure the monitoring agent;
gaining access by the cluster monitoring application to the cluster of servers with the access token prior to configuring, with the cluster monitoring application, the monitoring agent to transmit cluster operation data to the cluster monitoring application; and
wherein configuring, with the cluster monitoring application, the monitoring agent to transmit cluster operation data to the cluster monitoring application is in response to requesting that the cluster monitoring application configure the monitoring agent.

4. The method of claim 3, wherein requesting that the cluster monitoring application configure the monitoring agent comprises transmitting an application programming interface (API) call from the orchestrator application to the cluster monitoring application, wherein the API call requests that the cluster monitoring application configured the monitoring agent.

5. The method of claim 3, wherein the access token is an application programming interface (API) token.

6. The method of claim 1, further comprising:
receiving a configuration outcome message at the cluster monitoring application from the monitoring agent, wherein the configuration outcome message indicates whether configuring the monitoring agent was a success.

7. The method of claim 1, wherein the cluster monitoring application is an observability framework (OBF) application.

8. A computer device for configuring a cluster of servers, comprising:
one or more processors;
a memory that stores computer executable instructions, wherein, when the computer executable instructions are executed by the one or more processors, the one or more processors are configured to:
register the cluster of servers with an orchestrator application;
install a monitoring agent on the cluster of servers with the orchestrator application, wherein the orchestrator application is configured to generate agent configuration data in response to installing the monitoring agent;
send the agent configuration data to a cluster monitoring application in response to installing the monitoring agent;
configure, with the cluster monitoring application, the monitoring agent to transmit cluster operation data to the cluster monitoring application based on the sent agent configuration data.

9. The computer device of claim 8, wherein the computer executable instructions further configure the processor to:
prior to registering the cluster of servers with the orchestrator application, creating the cluster of servers with a cluster management application, wherein the cluster management application is configured to generate registration data with registration information associated with the cluster of servers;
wherein registering of the cluster of servers with the orchestrator application comprises sending the registration data with registration information associated with the cluster of servers to the orchestrator application.

10. The computer device of claim 8, wherein the computer executable instructions further configure the processor to:
storing an access token in a vault system in response to installing the monitoring agent on the cluster of servers, wherein the access token is usable to permit access the cluster of servers;
requesting that the cluster monitoring application configure the monitoring agent with the orchestrator application; and
obtaining the access token from the vault system at the cluster monitoring application in response requesting that the cluster monitoring application configure the monitoring agent;
gaining access by the cluster monitoring application to the cluster of servers with the access token prior to configuring, with the cluster monitoring application, the monitoring agent to transmit cluster operation data to the cluster monitoring application; and
wherein configuring, with the cluster monitoring application, the monitoring agent to transmit cluster operation data to the cluster monitoring application is in response to requesting that the cluster monitoring application configure the monitoring agent.

11. The computer device of claim 10, wherein requesting that the cluster monitoring application configure the monitoring agent comprises transmitting an application programming interface (API) call from the orchestrator application to the cluster monitoring application, wherein the API call requests that the cluster monitoring application configured the monitoring agent.

12. The computer device of claim 10, wherein the access token is an application programming interface (API) token.

13. The computer device of claim 8, wherein the computer executable instructions further configure the processor to:
receiving a configuration outcome message at the cluster monitoring application from the monitoring agent, wherein the configuration outcome message indicates whether configuring the monitoring agent was a success.

14. The computer device of claim 8, wherein the cluster monitoring application is an observability framework (OBF) application.

15. A computer product for configuring a cluster of servers, the computer product including computer executable instruction stored on a non-transitory computer readable media that when executed by one or more processors cause the one or more processors to:
register the cluster of servers with an orchestrator application;
install a monitoring agent on the cluster of servers with the orchestrator application, wherein the orchestrator application is configured to generate agent configuration data in response to installing the monitoring agent;
send the agent configuration data to a cluster monitoring application in response to installing the monitoring agent;
configure, with the cluster monitoring application, the monitoring agent to transmit cluster operation data to the cluster monitoring application based on the sent agent configuration data.

16. The computer product of claim 15, wherein the computer executable instructions further configure the processor to:
prior to registering the cluster of servers with the orchestrator application, creating the cluster of servers with a cluster management application wherein the cluster management application is configured to generate registration data with registration information associated with the cluster of servers;
wherein registering of the cluster of servers with the orchestrator application comprises sending the registration data with registration information associated with the cluster of servers to the orchestrator application.

17. The computer product of claim 15, wherein the computer executable instructions further configure the processor to:
storing an access token in a vault system in response to installing the monitoring agent on the cluster of servers, wherein the access token is usable to permit access the cluster of servers;
requesting that the cluster monitoring application configure the monitoring agent with the orchestrator application; and
obtaining the access token from the vault system at the cluster monitoring application in response requesting that the cluster monitoring application configure the monitoring agent; and
gaining access by the cluster monitoring application to the cluster of servers with the access token prior to configuring, with the cluster monitoring application, the monitoring agent to transmit cluster operation data to the cluster monitoring application; and
wherein configuring, with the cluster monitoring application, the monitoring agent to transmit cluster operation data to the cluster monitoring application is in response to requesting that the cluster monitoring application configure the monitoring agent.

18. The computer product of claim 17, wherein requesting that the cluster monitoring application configure the monitoring agent comprises transmitting an application programming interface (API) call from the orchestrator application to the cluster monitoring application, wherein the API call requests that the cluster monitoring application configured the monitoring agent.

19. The computer product of claim 17, wherein the access token is an application programming interface (API) token.

20. The computer product of claim 15, wherein the computer executable instructions further configure the processor to:
receiving a configuration outcome message at the cluster monitoring application from the monitoring agent, wherein the configuration outcome message indicates whether configuring the monitoring agent was a success.
